(19) United States
(12) Patent Application Publication
(10) Pub. No.: US 2026/0307348 A1
(43) Pub. Date: Oct. 8, 2026

(54) DEVICE FOR CONTROLLING PITCH AND TENSION OF A WIRE DEPOSITED ONTO MANDREL IN COMPOSITE-HOSE MANUFACTURING

(71) Applicant: GASSO EQUIPMENTS, S.A., SANT BOI DE LLOBREGAT, BARCELONA (ES)

(72) Inventors: Ignasi GASSÓ ESPINA, SANT BOI DE LLOBREGAT, BARCELONA (ES); Antonio FLOTATS MOLINAS, SANT BOI DE LLOBREGAT, BARCELONA (ES)

(21) Appl. No.: 19/485,175

(22) PCT Filed: Jun. 1, 2023
(86) PCT No.: PCT/ES2023/070365

§ 371 Date: Nov. 17, 2025

(51) Int. Cl. B29D 23/00; B65H 54/28; B65H 59/02

(52) U.S. Cl. CPC B29D 23/001; B65H 54/2896; B65H 59/02; B65H 2701/33

(57) ABSTRACT

A device for winding a wire around a mandrel in the manufacture of composite hoses with a controlling means for pitch and tension of the winded wire may include a carriage unit that moves laterally and coaxially in unison with the mandrel. The pitch of the wire is controlled by the carriage unit, two set of coaxial guidance rollers, first set of wire guidance groove rollers, and a carriage closed loop assisted mechanism. The tension is controlled by a pre-determined pressure that pushes displaceable rollers against two-fixed rollers passing the wire between them and bending the wire in a predetermined pull tension.

### TECHNICAL FIELD OF THE INVENTION

This invention generally relates to industrial composite hose manufacturing. More specifically, to a device for controlling the pitch and tension of a wire being deposited in a helical manner on a mandrel or on the external layer in a composite hose manufacturing machine.

### BACKGROUND OF THE INVENTION

Traditional rubber hoses, plastic hoses, and metal hoses cannot withstand the flexibility and constant flexing required, for storage in the minimum space or for uses in which the hoses are constantly subjected to flexing such as loading and unloading of ships. Composite hoses overcome the disadvantages associated with traditional rubber, plastic, and metal hoses due to their exceptional flexibility, thus making them an ideal choice for a range of applications and uses. Composite hoses are manufactured with multiple layers of helical-wrapped thermoplastic fabrics and films that are held together by a metal inner and outer wire helix. Presently, composite hoses are made with variations in the number of films and fabrics to provide a barrier to prevent fluid leaks and protection against fluids and products being carried.

A composite hose is typically manufactured by first installing a wire helix that acts as an internal support structure (i.e. inner wire). Then, a fabric sheet or plastic film material is wound around the wire helix in successive layers. A further helical wire (i.e. outer wire) is wound around the outermost film or sheet of fabric. This outer wire helix binds the fabric layers and film layers together. To form the inner wire helix, the fabric and film layers helices, and the outer wire helix, a mandrel is used as a supporting tool. Once the hose is finished, the hose is removed from the mandrel, sliding the entire hose along the entire length of the mandrel, towards one of the ends of the mandrel. The wire helix is formed, forming coil after coil in each turn of the mandrel, inducing residual stress in the wire due to strain, bending and torsion. Once the coil has been formed with the proper preset pitch, the wire tends to recover part of its original shape due to the elastic properties of the wire, not maintaining the preset pitch. To avoid pitch change, there must be friction between the formed coil wire and the mandrel to create forces that counteract this tendency to recover part of its original shape. This friction between the mandrel and the formed coil wire is achieved by means of the residual radial force that causes tensioning of the wire when the coil is formed on top of the mandrel. This radial force cannot be elevated because in this case the induced friction does not make it possible for the hose to slide when extracting the hose from the mandrel. We must tighten the wire in such a way that it allows to keep the pitch after forming the coil wire and that enables to extract the hose. As the inner wire helix and the outer wire helix are interspersed, the two spirals must maintain the angle and pitch throughout all the length of the hose. If the angle and pitch are not maintained throughout its length, the inner and outer helices overlap and the hose becomes defective and unusable. Maintaining the same parameters of the helix thread, angle, pitch, and tension, is difficult to obtain by manual methods, and achievable by semi-manual methods or open loop assisted mechanisms, however with a wide variability and oscillation of the parameters, and therefore the low quality of the hose. In composite hose manufacturing systems disclosed in the prior art, the inner wire, the outer wire and the film are sent to the rotating mandrel and the helix of wire is obtained by means of the mandrel which performs the mold function. The tension and angled guidance of the wire with respect to the perpendicular of the mandrel can be achieved by manual displacement and guidance of the material or by semimanual means by tools that pull or tension the wire, displaces and guides the wire, or by open loop assisted mechanisms and tools, or by monitored open loop assisted mechanism and tools. Further, as the inner wire helix and the outer wire helix are interspersed, the two-wire helix must maintain pitch throughout the length of the hose by always maintaining the same angle of deposition while the wire coils are formed one by one and once the wire coil is formed, the same pitch is maintained. In the case of the inner wire, a friction force between the wire coil with the mandrel is created, and in the case of the outer wire, the layers of fabric and film are compressed, so that each coil of wire is interspersed, sandwiched, compressed and fitted between pitch of the helix of the inner wire, by means of the residual radial tension of the wire coil formed through the tension of the wire when deposited on the mandrel, which has to be just the necessary to maintain the pitch of the wire coils already formed, and the compression between the layers of fabric and film, but not elevated to prevent elevated frictional force between the hose formed and the mandrel, caused by residual tension of the inner and outer wire helices, making it impossible to extract the hose along the entire length of the mandrel at one of its ends. If this pitch is not maintained throughout its length, the inner and outer helices overlap, and the hose is defective and unusable. To keep a constant pitch, a constant angle and a tension of the incoming wire is to be controlled that does exceed a minimum tension and to enable the hose to be removed the tension is to be controlled that it does not exceed a maximum tension.

Maintaining a constant pitch of both the inner and outer wire coils is not achievable with the existing system not even with monitored open loop assisted mechanism because the traditional motors used in the existing system show variations in the mechanical resistance and inertia rotation and therefore with respect to the wire carriage displacement. Although the repercussion of these resistances and inertias is reduced to a certain degree with the incorporation of reducers with a certain degree of irreversibility at the output of the motors, due to issues such as safety, large inertia of the mandrel, low mechanical efficiency and generated heat, endless vis gears are not used that would reduce these effects. Further, maintaining the same parameters of the helix pitch, angle, and tension, is difficult to obtain by manual methods, and achievable by semi-manual methods or open loop assisted mechanisms, however with a wide variability and oscillation of the parameters, and therefore the low quality of the hose.

Accordingly, it is apparent that a need exists for a device for controlling the pitch and tension of wire deposited on the mandrel in composite-hose manufacturing that can resolve many of the challenges of the existing systems and maintain constant parameters for producing high-quality composite hoses and allow it to be removed from the mandrel without compromising quality or damaging it in such a way that it is unusable. The present invention is directed towards addressing such dire needs for flexible composite hoses used for transporting fluid, LNG, LPG, oils, petroleum derivatives, NH3, chemicals, and other fluids.

### SUMMARY OF THE INVENTION

The first aspect of the invention provides a device for helical winding of a wire around a mandrel in the manufacture of composite hoses with a controlling means for the pitch of the winded wire. The device includes a carriage unit configured to move alongside the mandrel mounted on a longitudinal guide as the mandrel rotates about its axis. The carriage unit includes a means for guiding in a precise manner the helical winding wire that includes two sets of coaxial guidance rollers that move laterally and vertical in unison radially to the mandrel axis and swing coaxially in unison with the mandrel axis and a first set of wire guidance groove rollers that moves and swing in unison whit the previous ones sets of coaxial guidance rollers that guide the wire and with just the right tension to keep the wire into the roller grooves. The carriage unit includes a means for controlling the pitch of the helix wire as the wire is helically winded onto the mandrel or on an external layer of the composite hose. The means for controlling the pitch of the wire includes a closed loop assisted mechanism assembled to the carriage unit, that may include a motor, a sensor and a control unit, or a servomotor and the control unit that controls the carriage displacement alongside the mandrel, therefore the displacement alongside the mandrel of two sets of coaxial guidance rollers and the first set of wire guidance groove rollers, which are pushed by a first pneumatic cylinder. The control unit is configured in case of motor assisted carriage to regulate the carriage longitudinal speed by controlling the motor rotation speed or in case of servomotor assisted carriage to regulate carriage displacement by controlling servomotor rotation angle to maintain the pitch of the helical wounded wire at a constant predetermined value. The control unit in case of motor assisted carriage regulates the rotation speed of the motor referenced to rotation speed of the mandrel or in case of servomotor assisted carriage regulates carriage position based on the angle rotation positional data of the servomotor referenced to the rotation speed of the mandrel.

In some embodiments, the carriage closed loop assisted mechanism is configured to maintain a constant pitch. The pitch is predetermined for each composite hose diameter and typology, and type of the wire material, diameter of the wire material.

In some embodiments, the two sets of coaxial rollers and the first set of wire guidance groove rollers keep the application point of the wire in a precise position relative to the mandrel following the displacements and bendings of the mandrel.

In some embodiments, the first set of wire guidance groove rollers are guided by a supporting unit guided by the two sets of coaxial rollers configured to move and swing synchronously with the displacement of the accurate wire deposition point on the mandrel due to radial displacement and angular swing of the mandrel due to bending deformations between mandrel supports due to its own weight and rotational inertias.

In some embodiments, the positional data of the carriage unit is obtained using the displacement control of the carriage or angular control of the carriage closed loop assisted mechanism and the rotation speed of the mandrel is obtained using an angular control of the mandrel assisted mechanism.

In some embodiments, the carriage unit comprises, a means for controlling the tension of the wire as the wire is helical winded onto the mandrel or on the external layer of the composite hose, wherein the means for controlling the tension of the wire comprises a second set of wire guidance groove rollers arranged in zig-zag where the wire pass in between, one or more of them displaceable exert a force against the wire pushed by one or more second pneumatic cylinder simultaneously pushing the wire against the other fixed wire guidance groove rollers bending the wire in a predeterminate pull tension.

In some embodiments, the tension is predetermined for each composite hose diameter and typology, and type of the wire material and diameter of the wire material. The one or more second pneumatic cylinder is configured to maintain constant wire tension.

In some embodiments, the second set of wire guidance groove rollers comprise a displaceable roller and two fixed rollers.

In some embodiments, the carriage unit comprises, a means for controlling the tension of the wire as the wire is helical winded onto the mandrel or on the external layer of the composite hose wherein the means for controlling the tension of the wire comprises the second set of wire guidance groove rollers arranged in zig-zag where the wire pass in between, one or more of them displaceable pushed by a second pneumatic cylinder simultaneously exerts a force against the wire pushing the wire against the other wire guidance groove rollers bending the wire, to pull the wire it necessary to apply force and therefore tensioning the wire. The wire tension is controlled by a pre-determined force exerted by the pre-determinate pressure of the second pneumatic cylinder that pushes the displaceable roller against the two fixed rollers passing the wire between them and bending the wire as in a “chicane curve”.

In some embodiments, the tension wire material is selected according to metal wire mainly Aluminum, Steel, Stainless Steel and covered by Plastic, mainly Polytetrafluoroethylene (PTFE), Polypropylene (PP), Polyethylene (PE), Polyamide (PA).

The second aspect of the invention provides a device for winding a wire around a mandrel in the manufacture of composite hoses with a controlling means for the tension of the winded wire. The device includes a carriage unit configured to move alongside the mandrel mounted on a longitudinal guide as the mandrel rotates about its axis. The carriage unit includes (i) two sets of coaxial guidance rollers that move laterally and vertical in unison radially to the mandrel axis and swing coaxially in unison with the mandrel axis and (ii) a first set of wire guidance groove rollers that moves and swing in unison whit the previous ones sets of coaxial guidance rollers that guide the wire. The two sets of coaxial guidance rollers and the first set of wire guidance groove rollers are pushed by a first pneumatic cylinder. The carriage unit includes a means for controlling the tension of the wire as the wire is winded onto the mandrel or on the external layer of the composite hose. The means for controlling the tension of the wire includes a second set of wire guidance groove rollers arranged in zig-zag where the wire pass in between, one or more of them displaceable exerts a force against the wire pushed by a second pneumatic cylinder simultaneously pushing the wire against the other wire guidance groove rollers.

In some embodiments, the tension is predetermined for each type of wire material and the diameter of the wire material. The second pneumatic cylinder is configured to maintain constant tension.

In some embodiments, the second set of wire guidance groove rollers comprise a displaceable roller and two fixed rollers.

In some embodiments, the tension is controlled by a pre-determined force exerted by a pre-determined pressure of the second pneumatic cylinder that pushes the displaceable roller against the two fixed rollers passing the wire between them and deforming the wire as in a “chicane curve”.

In some embodiments, the wire material is selected from metal wire mainly Aluminum, Steel, Stainless Steel and in some cases covered by plastic as Polytetrafluoroethylene (PTFE), Polypropylene (PP), Polyethylene (PE), Polyamide (PA).

The device of the present inventions allows the achievement of the constant helix pitch of the inner wire and the outer wire by controlling the accurate displacement of the point of application of the wire and by accurate movement and swing of series of guidance rollers and grooved rollers that move and swing synchronously with the mandrel. The displacement of the theoretical point of application of the wire due to mandrel bending and the real displacement of the point of application of the wire is the same, obtaining the exact predetermined pitch, even though the theoretical point of application of the wire without mandrel bending and real application positions of the wire with mandrel bending do not coincide. The displacement of the carriage unit is controlled by a close loop assisted mechanism, that in case the use of servomotors with built-in encoders is much better accurate due to the elevated synchronization during accelerations and decelerations. The device of the present inventions also allows accurate adjustment of the helix wire tension, between a minimum tension to ensure that the formed wire helix maintains predetermined exact pitch on all its coils and a maximum tension to allow hose extraction without diminishing quality or damaged making it useless, by means of a system of fix and displaceable grooved rollers that apply a predetermined force controlled by a pneumatic cylinder with a predetermined pressure, to flex the wire as it passes between the grooved rollers and thus create a predetermined wire tension between the minimum and the maximum tension.

### BRIEF DESCRIPTION OF THE DRAWINGS

A clear understanding of the key features of the invention summarized above may be had by reference to the appended drawings, which illustrate the method and system of the invention, although it will be understood that such drawings depict preferred embodiments of the invention and, therefore, are not to be considered as limiting its scope with regard to other embodiments which the invention is capable of contemplating. Accordingly:

FIG. 1 illustrates a device for helically winding a wire around a mandrel in the manufacture of composite hoses with a controlling means for pitch of the winded wire, in accordance with various embodiments of the present invention.

FIG. 2A-2B illustrates the carriage assisted mechanism of the device of FIG. 1 in accordance with various embodiments of the present invention.

FIG. 3A illustrates the front view of the device of FIG. 1 to perceive the movement and swing of the coaxial guidance rollers and the wire guidance groove rollers in accordance with various embodiments of the present invention.

FIG. 3B illustrates the cross-sectional view of the carriage unit of FIG. 3A to perceive the movement and swing of the coaxial guidance rollers and the wire guidance groove rollers and the point of application of the wire in accordance with various embodiments of the present invention.

FIG. 4 illustrates the top view of the device of FIG. 1 to perceive the movement and swing of the coaxial guidance rollers and the wire guidance groove rollers in accordance with various embodiments of the present invention.

FIG. 5 illustrates a device for helical winding a wire around a mandrel in the manufacture of composite hoses with a controlling means for the tension of the winded wire in accordance with various embodiments of the present invention.

FIG. 6A illustrates the front view of the carriage unit of FIG. 5 to perceive control wire tension groove rollers in accordance with various embodiments of the present invention.

FIG. 6B illustrates the cross-sectional view of the carriage unit of FIG. 6A to perceive the controlling wire tension groove rollers and bending between wire tension groove rollers to generate wire tension in accordance with various embodiments of the present invention.

FIG. 7 illustrates a device for helical winding a wire around a mandrel in the manufacture of composite hoses with a controlling means for pitch and tension of the winded wire using one or more second pneumatic cylinder, in accordance with various embodiments of the present invention.

FIG. 8A illustrates the front view of the carriage unit of the device of FIG. 7 to perceive the movement and swing of the coaxial guidance rollers and the wire guidance groove rollers and wire tension groove rollers in accordance with various embodiments of the present invention.

FIG. 8B illustrates the cross-sectional view of the carriage unit of the device of FIG. 7 to perceive the movement and swing of the coaxial guidance rollers and the wire guidance groove rollers, the point of application of the wire and the wire bending between wire tensions groove rollers to generate wire tension in accordance with various embodiments of the present invention.

FIG. 9A-9B illustrates the carriage close loop assisted mechanism of the device of FIG. 7 in accordance with various embodiments of the present invention.

FIG. 10 illustrates a general computer or PLC architecture that can be appropriately configured to implement components disclosed in accordance with various embodiments of the present invention.

Like reference numerals refer to like parts throughout the several views of the drawings.

### DETAILED DESCRIPTION OF THE PREFERRED EMBODIMENTS

The terminology used herein is for the purpose of describing particular embodiments only. It is not intended to be limiting to the invention. As used herein, the term “and/or” includes any and all combinations of one or more of the associated listed items. The singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein. In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and inventions should be read with the understanding that such combinations are entirely within the scope of the invention and the claims of the device for controlling the pitch and tension of wire deposited on the mandrel in composite-hose manufacturing as discussed herein. In the following description, for purposes of explanation, numerous specific details are set forth in order to provide a thorough understanding of the present invention. It will be evident, however, to one skilled in the art that the present invention may be practiced without these specific details. The present disclosure is to be considered an exemplification of the invention and is not intended to limit the invention to the specific embodiments illustrated by the figures or description below. The present invention will now be described by referencing the appended figures representing preferred embodiments.

FIG. 1 illustrates a device for helically winding a wire around a mandrel in the manufacture of composite hoses with a controlling means for pitch of the winded wire, in accordance with various embodiments of the present invention. The device 100 includes a carriage unit 102 configured to move alongside the mandrel 104 mounted on a longitudinal guide as the mandrel 104 rotates about its axis. The carriage unit 102 includes two sets of coaxial guidance rollers 106A-D that move laterally, and vertical in unison radially to the mandrel 104 axis and swing coaxially in unison with the mandrel 104 axis and a first set of wire guidance groove rollers 108A-B (108 A Not visible in FIG. 1) that guide the wire 110.

The carriage unit 102 includes a means for controlling the pitch of the wire helix 111 as the wire 110 is helically winded onto the mandrel 104 or on an external layer of the composite hose. The means for controlling the pitch of the wire helix 111 includes a carriage close loop assisted mechanism 112-119 that control the displacement alongside the mandrel 104 and the two sets of coaxial guidance rollers 106A-D and the wire guidance groove rollers 108A-B that are pushed and actuated by a first pneumatic cylinder 107A-B. The carriage close loop assisted mechanism 112-119 includes a carriage motor 112, a carriage position sensor 117, if carriage motor 112 is a servomotor with an inbuilt angular sensor, a mandrel rotation speed sensor 119, a rotation speed signal 118, if mandrel motor is a servomotor with an inbuilt angular sensor, a control unit 116, a feedback signal 115 from control unit 116 to the carriage motor 112. A mandrel motor 120 is not part of the close loop. The mandrel motor 120 is an Open Loop Assisted Mechanism. The mandrel motor does not have a feedback signal from the control unit 116. The RPM of the mandrel 104 is pre-determined by the user. The two sets of coaxial guidance rollers 106A-D and the first set of wire guidance groove rollers 108A-B keep the point of application 109 (109 Not visible in FIG. 1) of the wire 110 in a precise position relative to the mandrel 104. The first set of wire guidance groove rollers 108A-B are guided by a supporting unit that is guided by the two sets of coaxial guidance rollers 106A-D configured to move and swing synchronously with the displacements due to bending of the mandrel 104. The mandrel 104 flexes changing the theorical position of the point of application of the wire 109 to maintain the position of the point of application of the wire 109. The two sets of coaxial guidance rollers 106A-D follow the mandrel 104 moving and swinging. A control unit 116 is configured to regulate the rotation of the carriage close loop assisted mechanism 112-119 to maintain the pitch of the helical wounded wire 111 at a constant predetermined value. The control unit 116 regulates the displacement of the carriage unit 102 in relation to mandrel speed rotation by regulating the rotation of the carriage close loop assisted mechanism 112-119 based on the positional data of the carriage unit 102 and the rotation speed of the mandrel 104. The positional data of the carriage unit 102 is obtained using a carriage position signal 114 of the carriage position sensor 117 of the carriage close loop assisted mechanism 112-119 and the rotation speed of the mandrel 104 is obtained using a rotation speed signal 118 from the mandrel rotation speed sensor 119 (not shown in FIG. 1) of the mandrel close loop assisted mechanism (not shown in FIG. 1). In case that the assisted mechanism of the carriage unit 102 and the mandrel 104 are servomotors, sensors are integrated, in and outputs signals 114, 118 comes from the servomotors.

The pitch is predetermined for each composite hose diameter, and typology and type of the wire material, diameter of the wire material. The carriage close loop assisted mechanism 112-119 is configured to maintain a constant pitch. The wire material is selected from metal wire mainly Aluminum, Steel, stainless steel and in some cases covered by plastic, mainly Polytetrafluoroethylene (PTFE), Polypropylene (PP), Polyethylene (PE), Polyamide (PA). The series of carriage rollers (i.e.) the two sets of coaxial guidance rollers 106A-D and the first set of wire guidance groove rollers 108A-B moves laterally, and vertical in unison radially to the mandrel 104 and swing coaxially in unison with the mandrel 104. Thus, if the mandrel 104 moves laterally and vertically or bends (causing curvature), the series of carriage rollers and the mandrel 104 maintain their distance and perpendicularity. The coaxial guidance rollers 106A-D that are closest to the mandrel 104 move in the Axial “X” direction to the mandrel 104 due to the predetermined and controlled movement of the carriage unit 102. These coaxial guidance rollers 106A-D have two displacements to be controlled mainly in “Z” direction and secondary in “Y” direction with three swing or tiltings mainly about “Y” direction and secondary about “X” direction, optional in “Z” direction. The wire guidance groove rollers 108A-B follow in unison the movements of the coaxial guidance rollers 106A-D which provides an elevated improvement in the regular deposition of 1 revolution, 1 coil wire, but does not affect to maintain the pitch in the whole formed set (more than 1500 coils). By virtue of two displacements and two (three) swings of the wire placing of wire guidance grooved roller 108A, it can move and swing synchronized with the push-ups of the mandrel 104. The mandrel 104 has movements by bending mainly in “Z” direction due to weight that cause a bending in “Y” direction and secondary in “Y” direction due to the tension of the wire 110 that cause a bending in “Z” direction. The displacement and bends of the mandrel 104 cause the displacement of the deposition point of the wire 110 slightly in mandrel axis direction.

The point of wire application 109 determined by wire guidance grooved roller 108A must be as close to the mandrel 104 to move as synchronously with the mandrel 104, however, if it is almost touching the oscillations of the mandrel deformations due to bending and inertia, they are not properly damped, amplifying the oscillations in wire application point 109. A small distance of a few mm allows damping these oscillations and quickly restoring the point of application 109, hence the distance relation between the coaxial guidance roller 106A-D and wire guidance grooved roller 108A and the mandrel 104 has to be precisely determined.

Once the inner wire helix has been made on the mandrel 104, the fabric and film helical winding is done in a way that each subsequent layer is placed over the previous one in a back and forth motion while the mandrel 104 continues to rotate depositing fabric and film helix in opposite winding directions until the final outer cover layer is reached. An outer helical wire element is then wound in a helix pattern over the cover layer, positioned between the predetermined pitch spacing of the inner wire element. The inner and outer helical wire elements are commonly standard circular wire while being constructed from a material selected from the group consisting of steel, stain steel, aluminum, sometimes covered by plastic or composite material. The predetermined spacing or pitch of the inner helical wire element is typically generally between 1 to 30 mm depending on the composite hose diameter, typology, material and diameter of the wire 110 and the composite hose. The outer helical wire element is configured to be placed in between the predetermined pitch spacing of the inner helical wire 111 element. If the relation of axial speed of the wire application point 109 and the speed rotation of the mandrel 104 is kept constant and the tension on the wire 110 is constant, the resulting helix will have a constant angle, pitch, diameter and residual tension. The tension of the wire of the outer helix must be minimally sufficient to compress the fabrics and the film between the outer helical wire and the inner helical wire. If the hose is compressed too much in order to obtain a tight hose without leaks, causes compression of the inner helical wire 111 against the mandrel 104, causing too much friction in the extraction of the hose between the inner helical wire 111 and the mandrel 104, damaging the quality of the hose, made it useless or impossible to extract.

The carriage close loop assisted mechanism 112-119 rotates “n” turns as a function of the desired wire pitch which is given by the next formula:

$$n = \begin{matrix}\begin{matrix}\# turns of \\ Carriage\end{matrix} \\ Servomotor\end{matrix} = \begin{matrix}\# turns of \\ Mandrel \\ Motor\end{matrix} [ \frac{π - rack Pinion Pitch Diameter}{Predetermined Wire Pitch} ]$$

For example, if the wire pitch is 17 mm for the mandrel rotation of 180°, then n=½ turns=0.5. If the gear pitch diameter of the gear rack mechanism is 50 mm, then the gear pitch circumference is 157 mm. Then 1/(157/17)=17/157=0.108, and n=0.5*0.108=0.065=19.44° in this numerical example. Hence, Carriage displacement equals 157 (19.44/360)=8.4=half the pitch corresponding to half a turn of the mandrel 104. Speed is a result of the position control, if 180 degrees is turned, i.e. half a turn, then the speed of the mandrel 104 equals 0.5 rpm and that of servomotor 112 equals 0.5*0.108=0.054 rpm.

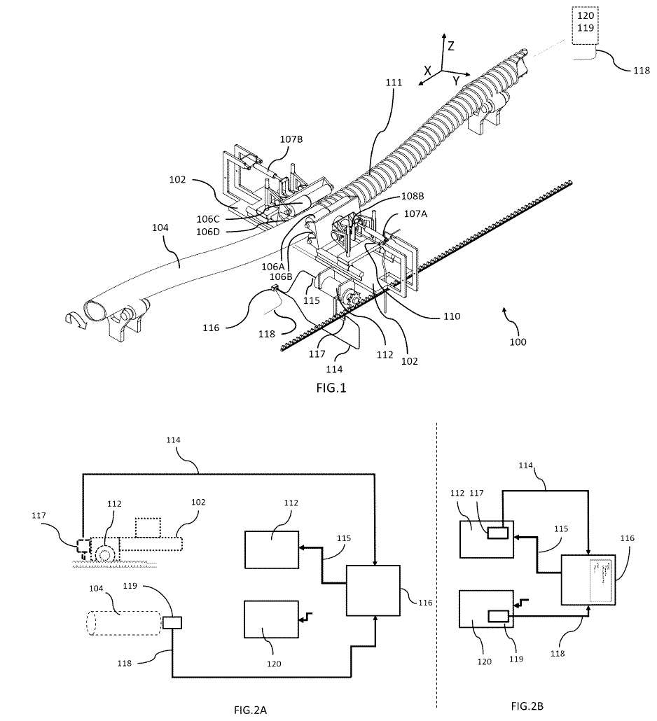

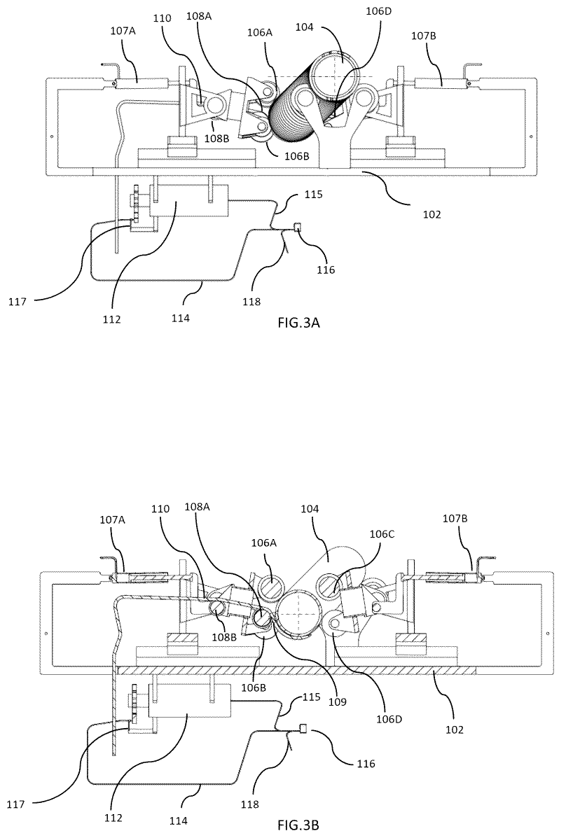

FIG. 2A-2B illustrates the carriage assisted mechanism of the device of FIG. 1 in accordance with various embodiments of the present invention. In particular, FIG. 2A illustrates a typical close loop: motor 112 (Assisted Mechanism) plus a separated sensor. FIG. 2B illustrates a close loop alternative embodiment, with a servomotor 112 equipped with a built-in sensor 117. The control unit 116 includes a processor that executes a logic control algorithm to keep the pitch of the helical wounded wire 111 at a constant predetermined value in relation to the mandrel speed rotation. In case the control unit 116 is PLC type, the memory includes all host composite hose references, their respective diameters, by-default pitch, maximum pressures, fluids, applications, etc and upon selection of the host model, the logic control algorithm selects the pitch. The logic control algorithm may select the pitch based on the selection of the host composite hose model. Optionally, the operator may also select a different pitch. The control unit 116 uses the positional data of the carriage unit 102 using the carriage position signal 114 of the carriage position sensor 117 of the carriage servomotor 112, in case of carriage-assisted mechanism 112-119 is a servomotor 112 using the angular sensor of the carriage servomotor 112, and the rotation speed signal 118 of the mandrel 104 obtained using the mandrel rotation speed sensor 119, in case of mandrel assisted mechanism is a servomotor 120 using the angular sensor of the mandrel servomotor 120. Each revolution of the mandrel 104 corresponds to one Displacement=WIRE STEP=Displacement carriage unit pitch. The mandrel rotation speed (RPM), “Z”, implies a carriage displacement speed=Z*PITCH/Minute”. The pitch control is determined by the carriage close loop assisted mechanism 112-119 and the mandrel assisted mechanism by the guidance of the two sets of coaxial guidance rollers 106A-D and wire guidance groove rollers 108A-B that deposit the wire 110 in the mandrel 104. The Displacement carriage unit control is performed to control the pitch by means of the carriage close loop assisted mechanism 112-119, the angular sensor of the carriage servomotor 112, the carriage position signal 114, the control unit 116, a rotation speed signal 118 of the mandrel rotation speed sensor 119 of the mandrel assisted mechanism. A close loop control software (e.g. PID, PLC) is executed to control the relation between displacements of the carriage unit 102 and mandrel 104 rotation speed. The pitch control is initialized by (i) setting and introduction of pitch through the touchscreen or keypad, (ii) determination of rotation speed (rpm) of the mandrel 104 and the positional signal of the carriage unit 102, (iii) In case, the control unit 116 is PLC type, the pitch is automatically selected by user selection of a composite hose reference in a human interface device.

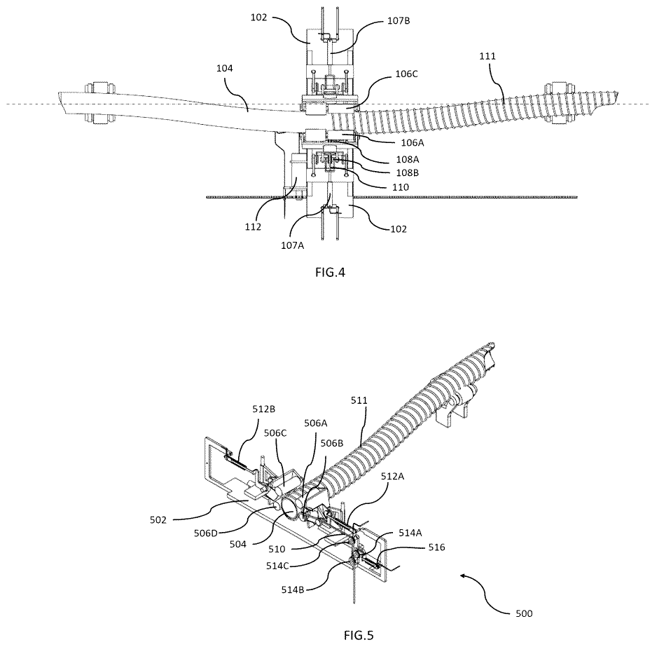

FIG. 3A illustrates the front view of the device of FIG. 1 to perceive the movement and swing of the coaxial guidance rollers and the wire guidance groove rollers are shown in accordance with various embodiments of the present invention. The carriage unit 102 includes a means for controlling the pitch of the wire 110 as the wire 110 is helically winded onto the mandrel 104 or on the external layer of the composite hose. The means for controlling the pitch of the wire 110 includes a carriage close loop assisted mechanism 112-119 that control the displacement alongside the mandrel 104 and the two sets of coaxial guidance rollers 106A-D and the first set of wire guidance groove rollers 108A-B that are pushed actuated by the first pneumatic cylinder 107A-B. The two sets of coaxial guidance rollers 106A-D and the first set of wire guidance groove rollers 108A-B keep the wire application point 109 in a precise position relative to the mandrel 104. The first set of wire guidance groove rollers 108A-B are guided by a supporting unit that is guided by two sets of coaxial guidance rollers 106A-D configured to move and swing synchronously with the displacements and bending of the mandrel 104. The control unit 116 is configured to regulate the angular rotation of the carriage close loop assisted mechanism 112-119 to maintain the pitch of the helical wounded wire 111 at a constant predetermined value. The control unit 116 regulates the rotation of the carriage close loop assisted mechanism 112-119 based on the positional data of the carriage unit 102 and the rotation speed of the mandrel 104. If carriage assisted mechanism is a servomotor the positional data of the carriage unit 102 is obtained using the carriage position sensor 117 of the carriage servomotor 112 and the rotation speed of the mandrel 104 is obtained using the mandrel rotation speed sensor 119. If mandrel assisted mechanism is a servomotor the positional data of the mandrel 104 is obtained using the angular sensor of the mandrel servomotor 120.

FIG. 3B illustrates the cross-sectional view of the carriage unit of FIG. 3A to perceive the movement and swing of the coaxial guidance rollers and the wire guidance groove rollers and the point of application of the wire in accordance with various embodiments of the present invention. The cross-sectional view of the carriage unit 102 shows the mandrel 104, the two sets of coaxial guidance rollers 106A-D, the first set of wire guidance groove rollers 108A-B, the wire application point 109, the carriage close loop assisted mechanism 112-119, the first pneumatic cylinder 107A-B and the control unit 116. The functioning of the carriage unit 102 has been described in FIG. 3A.

FIG. 4 illustrates the top view of the device of FIG. 1 to perceive the movement and swing of the coaxial guidance rollers and wire guidance groove rollers in accordance with various embodiments of the present invention. The top view of the device 100 shows the carriage unit 102, the mandrel 104, the two sets of coaxial guidance rollers 106A-D, the carriage close loop assisted mechanism 112-119, and the first pneumatic cylinder 107A-B. The functioning of the device has been described in FIG. 1.

FIG. 5 illustrates a device for helical winding a wire around a mandrel in the manufacture of composite hoses with a controlling means for the tension of the winded wire in accordance with various embodiments of the present invention. The device 500 includes a carriage unit 502, a mandrel 504, two sets of coaxial guidance rollers 506A-D, a first set of wire guidance groove rollers 508A-B, a first pneumatic cylinder 512A-B, a second set wire guidance groove rollers 514A-C (a displaceable roller 514A, and two fixed rollers 514B-C), one or more second pneumatic cylinder 516, and the wire 510. The carriage unit 502 is configured to move alongside the mandrel 504 mounted on a longitudinal guide as the mandrel 504 rotates about its axis. The carriage unit 502 includes two sets of coaxial guidance rollers 506A-D that moves laterally and vertical in unison radially to the mandrel 104 and swing coaxially in unison with the mandrel 104 and a first set of wire guidance groove rollers 508A-B that guide the wire 510. The two sets of coaxial guidance rollers 506A-D are pushed by a first pneumatic cylinder 512A-B. The carriage unit 502 includes a means for controlling the tension of the wire 510 to be applied on the mandrel 504 or an external layer of the composite hose. The means for controlling the tension of the wire 510 includes the one or more second pneumatic cylinder 516, the second set wire guidance groove rollers 514A-C (the displaceable roller 514A, and the two fixed rollers 514B-C). The tension is controlled by the pre-determined force exerted by one or more second pneumatic cylinder 516 at a pre-determined pressure that pushes the displaceable roller 514A against the two fixed rollers 514B-C passing the wire 510 between them and bending the wire as in a “chicane curve” by the one or more second pneumatic cylinder 516 being necessary to apply a force to pull the wire and therefore creating tension in the wire 510. The tension is predetermined for each hose diameter and typology, type of the wire material and the diameter of the wire material. The one or more second pneumatic cylinder 516 is configured to maintain a constant tension as the mandrel 504 stretches the wire 510 when helical winding around it. If the tension is regulated only with stationary rollers like the usual wire straightener, the sudden and abrupt movements and bending of the mandrel 504 cause sudden and abrupt changes and oscillations in the tension of the wire 510, due to the forces of inertia. On the other hand, if a roller is displaceable and a predetermined force is exerted on it, it damps said sudden and abrupt changes and oscillations of tension in the wire 510.

The tension affects the pitch in two situations. One at the time of depositing of the wire 510 in the application point on the mandrel 504, a low tension causes situations of push or pull Real Point Application, therefore resulting in inaccuracies. The other one just after the time of depositing of the wire. Low tension causes the wire coil not to conform exactly to the diameter of the mandrel 504. Once the helix has been formed on the mandrel 504, due to the flexibility of the material of the wire 510, it expands and has a larger diameter than the mandrel 504. If the helix is of a larger diameter than the mandrel 504, it does not friction against the mandrel 504, and therefore loses its pitch, because the wire 510 being twisted when deposited in the form of a helix on the mandrel 504, introduces torsional stresses, which have a spring effect and the coils contract or expand. A high tension makes a helix of a perfect pitch, but then the hose cannot be exact alongside the mandrel 504, due to an excess of friction between mandrel 504 and the helix wire 511. In the outer wire helix, the tension control has the same objectives as in the inner wire helix, adding the objective of compressing the layers of fabrics and films that are interposed between the two wire helixes. The wire tension is controlled by applying enough tension to compress the fabrics and films layers so that there is no fluid leakage without compressing the hose too much so as not to compress the inner helix and then the hose will not be exact due to friction with the mandrel 504. In this case, the control of the wire tension is somewhat more sensitive, since apart from being part of the control and maintenance of the constant pitch and establishing a tension that allows the extraction of the hose, it must fulfill another objective, the necessary compression of the layers of fabric and film to prevent leaks in the hose.

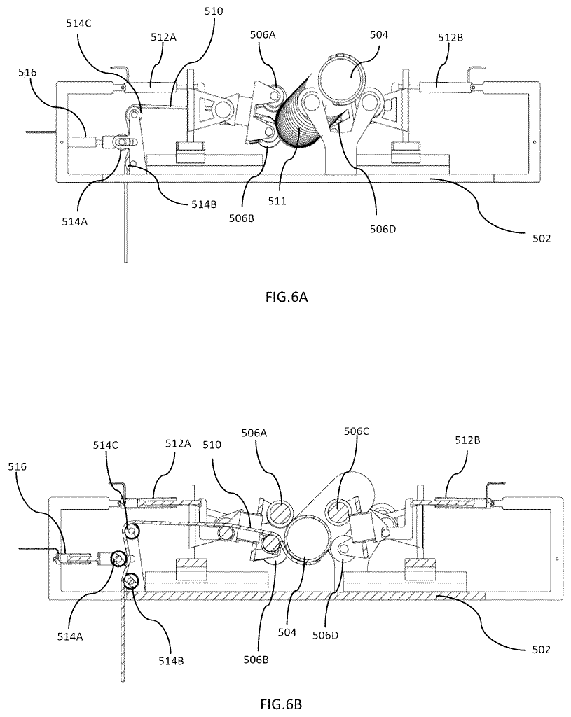

FIG. 6A illustrates the front view of the carriage unit of FIG. 5 to perceive control wire tension groove rollers in accordance with various embodiments of the present invention. The carriage unit 502 is configured to move alongside the mandrel 504 mounted on a longitudinal guide as the mandrel 504 rotates about its axis. The carriage unit 502 is configured to move alongside the mandrel 504 mounted on a longitudinal guide as the mandrel 504 rotates about its axis. The carriage unit 502 includes two sets of coaxial guidance rollers 506A-D that move laterally, and vertical in unison radially to the mandrel 504 and swing coaxially in unison with the mandrel 504 and the first set of wire guidance groove rollers 508A-B that guide the wire 510. The two sets of coaxial guidance rollers 506A-D are pushed by the first pneumatic cylinder 512A-B. The carriage unit 502 includes a means for controlling the tension of the wire 510 to be applied on the mandrel 504 or an external layer of the composite hose. The means for controlling the tension of the wire 510 includes one or more second pneumatic cylinders 516, the displaceable roller 514A, and the two fixed rollers 514B-C. The one or more second pneumatic cylinder 516 is configured to maintain a constant tension as the mandrel 504 stretches the wire 510 when winding around it. The functioning of the carriage unit 502 for controlling the tension has been described in FIG. 5.

FIG. 6B illustrates the cross-sectional view of the carriage unit of FIG. 6A to perceive the controlling wire tension groove rollers and bending between wire tension groove rollers to generate wire tension in accordance with various embodiments of the present invention. The cross-sectional view of the carriage unit shows the mandrel 504, one or more second pneumatic cylinder 516, the displaceable roller 514A, the two fixed rollers 514B-C, the wire 510, the coaxial guidance rollers 506A-D, the first pneumatic cylinder 512A-B. The one or more second pneumatic cylinder 516 is configured to maintain a constant tension as the mandrel 504 stretches the wire 510 when winding around it. The functioning of the carriage unit 502 for controlling the tension has been described in FIG. 5.

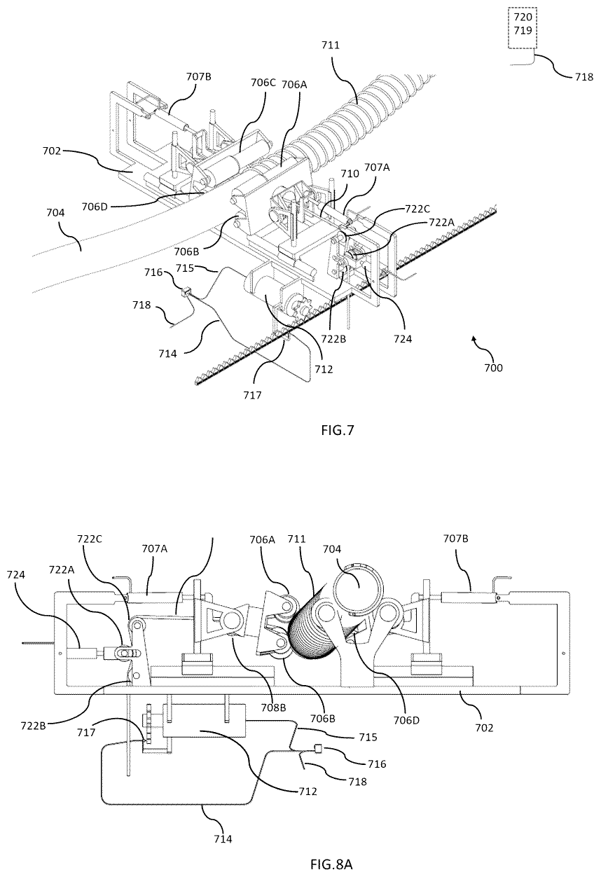

FIG. 7 illustrates a device for helical winding a wire around a mandrel in the manufacture of composite hoses with a controlling means for pitch and tension of the winded wire using one or more second pneumatic cylinder, in accordance with various embodiments of the present invention. The device 700 includes a carriage unit 702 configured to move alongside the mandrel 704 mounted on a longitudinal guide as the mandrel 704 rotates about its axis. The carriage unit 702 includes two sets of coaxial guidance rollers 706A-D laterally, and vertical in unison radially to the mandrel 104 and swing coaxially in unison with the mandrel 104 and a first set of wire guidance groove rollers 708 A-B (708A Not visible in FIG. 7) that guide the wire 710.

The carriage unit 702 includes a means for controlling the pitch of the wire helix 711 as the 710 wire is helically winded onto the mandrel 704 or on a final external layer of the composite hose. The means for controlling the pitch of the wire helix 711 includes a carriage closed loop assisted mechanism 712-719 that controls the displacement alongside the mandrel 704 and two sets of coaxial guidance rollers 706A-D and the first set of wire guidance groove rollers 708A-B that are pushed by a first pneumatic cylinder 707A-B. The carriage close loop assisted mechanism 712-719 includes a carriage motor 712, a carriage position sensor 717, if carriage motor 712 is a servomotor with an inbuilt angular sensor, a mandrel rotation speed sensor 719, rotation speed signal 718, if mandrel motor is a servomotor with an inbuilt angular sensor, a control unit 716, a feedback signal 715 from the control unit 716 to the carriage motor 712. A mandrel motor 720 is not part of the close loop. The mandrel motor 720 is an Open Loop Assisted Mechanism. The mandrel motor does not have a feedback signal from the control unit 716. The RPM of the Mandrel 704 is pre-determined by the user. The two sets of coaxial guidance rollers 706A-D and the first set of wire guidance groove rollers 708A-B keep the point of application of the wire 709 (709 Not visible in FIG. 7) in a precise position relative to the mandrel 704. The first set of wire guidance groove rollers 708A-B are guided by a supporting unit that is guided by two sets of coaxial guidance rollers 706A-D configured to move and swing synchronously with the displacements due to bending of the mandrel 704. The mandrel 704 moves and flexes by changing the theorical position of the point of application of the wire 709 to maintain the point of application of the wire 709 as the two sets of coaxial guidance rollers 706A-D follow the mandrel 704 moving and swinging. A control unit 716 is configured to regulate the rotation of the carriage closed loop assisted mechanism 712 to 719 to maintain the pitch of the helical wounded wire 711 at a constant predetermined value. The control unit 716 regulates the displacement of the carriage unit 702 in relation to mandrel speed rotation by regulating the rotation of the carriage close loop assisted mechanism 712 to 719 based on the positional data of the carriage unit 702 and the rotation speed of the mandrel 704. The positional data of the carriage unit 702 is obtained using the carriage position sensor 717 of the carriage close loop assisted mechanism 712 to 719 and the rotation speed of the mandrel 704 is obtained using the mandrel rotation speed sensor 719 (not shown in FIG. 7) of the mandrel close loop assisted mechanism. In case that the assisted mechanism of the carriage unit 702 and the mandrel 704 is a servomotor, sensors are integrated, in and output signals 714, 718 comes from the servomotors. The pitch is predetermined for each composite hose diameter and typology, and type of the wire material, diameter of the wire material. The carriage close loop assisted mechanism 712-719 is configured to maintain a constant pitch. The wire material is selected from metal wire mainly Aluminum, Steel, stainless steel and in some cases covered by plastic material, Polytetrafluoroethylene (PTFE), Polypropylene (PP), Polyethylene (PE), Polyamide (PA). The carriage unit 702 includes a means for controlling the tension of the helix wire 711 by controlling as the wire 710 helical winds onto the mandrel 704 or on a final external layer of the composite hose. The means for controlling the tension of the wire 710 includes a second set of wire guidance groove rollers 722A-C arranged in zig-zag where the wire 710 passes in between one or more of them exert a force against the wire 710 pushed by one or more second pneumatic cylinder 724 simultaneously pushing the wire 710 against the other guidance groove rollers. The second set of wire guidance groove rollers 722A-C includes a displaceable roller 722A and two fixed rollers 722B and 722C. The tension is controlled by the pre-determined force exerted by one or more second pneumatic cylinder 724 at a pre-determined pressure that pushes the displaceable roller 722A against the two fixed rollers 722B and 722C passing the wire 710 between them and bending the wire as in a “chicane curve” by one or more second pneumatic cylinder 724 being necessary to apply a force to pull the wire and therefore creating tension in the wire. The tension is predetermined for each type of the wire material and the diameter of the wire material. The one or more second pneumatic cylinder 724 is configured to maintain constant tension as the mandrel 704 stretches the wire 710 when helically winding around it.

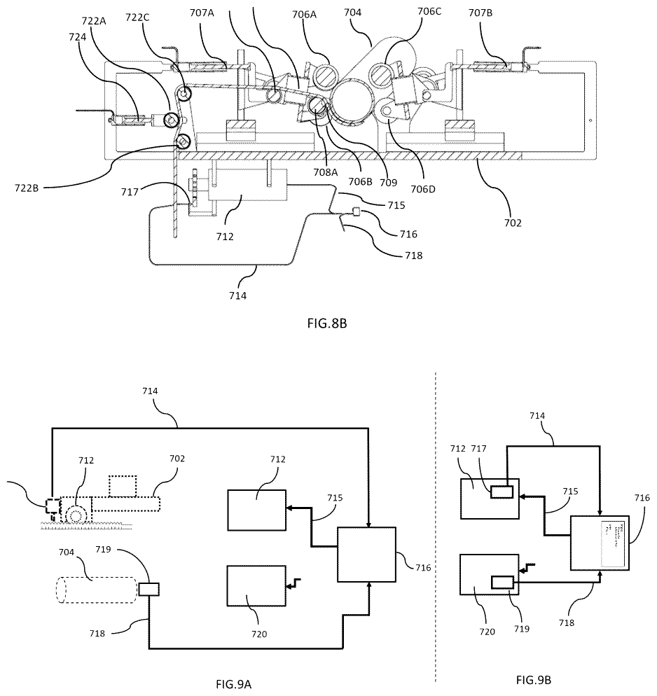

FIG. 8A illustrates the front view the carriage unit of the device of FIG. 7 to perceive the movement and swing of guidance rollers and wire guidance groove rollers and wire tension groove rollers in accordance with various embodiments of the present invention. The carriage unit 702 includes a means for controlling the pitch of the wire 710 as the wire 710 is helical winded onto the mandrel 704 or on the external layer of the composite hose. The means for controlling the pitch of the wire 710 includes a carriage close loop assisted mechanism 712-719 that control the displacement alongside the mandrel 704 and the two sets of coaxial guidance rollers 706A-D and the first set of wire guidance groove rollers 708A-B that are pushed actuated by the first pneumatic cylinder 707A-B. The two sets of coaxial guidance rollers 706A-D and the first set of wire guidance groove rollers 708A-B keep the wire application point 709 in a precise position relative to the mandrel 704. The first set of wire guidance groove rollers 708A-B are guided by a supporting unit that is guided by two sets of coaxial guidance rollers 706A-D configured to move and swing synchronously with the displacements and bending of the mandrel 704. The control unit 716 is configured to regulate the angle rotation of the carriage close loop assisted mechanism 712-719 to maintain the pitch of the helical wounded wire 711 at a constant predetermined value. The control unit 716 regulates the rotation of the carriage close loop assisted mechanism 712-719 based on the positional data of the carriage unit 702 and the rotation speed of the mandrel 704. If carriage assisted mechanism is a servomotor the positional data of the carriage unit 702 is obtained using the carriage position sensor 717 of the carriage servomotor 712 and the rotation speed of the mandrel 704 is obtained using the mandrel rotation speed sensor 719. If mandrel assisted mechanism 718 is a servomotor the positional data of the mandrel 704 is obtained using the mandrel rotation speed sensor 719 of the mandrel servomotor 720. The two sets of coaxial guidance rollers 706A-D are pushed by the first pneumatic cylinder 707A-B. The carriage unit 702 includes a means for controlling the tension of the helix wire 711 to be applied on the mandrel 704 or an external layer of the composite hose. The means for controlling the tension of the wire 710 includes one or more second pneumatic cylinder 724, the displaceable roller 722A, and the two fixed rollers 722B-C. The one or more second pneumatic cylinder 724 is configured to maintain a constant tension as the mandrel 704 stretches the wire 710 when winding around it. The functioning of the carriage unit 702 for controlling the tension has been described in FIG. 7.

FIG. 8B illustrates the cross-sectional view of the carriage unit of the device of FIG. 7 to perceive the movement and swing of guidance rollers and wire guidance groove rollers, the point of application of the wire and the wire bending between wire tensions groove rollers to generate wire tension in accordance with various embodiments of the present invention. The cross-sectional view shows the carriage unit 702, the mandrel 704, the two sets of coaxial guidance rollers 706A-D, the wire 710, the first pneumatic cylinder 707A-B, the control unit 716, one or more second pneumatic cylinder 724, the displaceable roller 722A, the two fixed rollers 722B and 722C. The functioning of the carriage unit 702 for controlling the tension has been described in FIG. 7.

FIG. 9A-9B illustrates the carriage close loop assisted mechanism of the device of FIG. 7 in accordance with various embodiments of the present invention. In particular, FIG. 9A illustrates a typical close loop: motor 712 (Assisted Mechanism) plus a separated sensor. FIG. 9B illustrates a close loop alternative embodiment, with a servomotor 712 equipped with a built-in sensor 717. The control unit 716 includes a processor that executes a logic control algorithm to keep the pitch of the helical wounded wire 711 at a constant predetermined value in relation to the mandrel speed rotation. In case the control unit 716 is PLC type, the memory includes all host composite hose references, their respective diameters, by-default pitch, maximum pressures, fluids, applications, etc and upon selection of the host model, the logic control algorithm selects the pitch. The logic control algorithm may select the pitch based on the selection of the host composite hose model. Optionally, the operator may also select a different pitch. The control unit 716 uses the positional data of the carriage unit 702 using carriage position signal 714 of the carriage position sensor 117 of the carriage servomotor 712, in case of carriage-assisted mechanism 712-719 is a servomotor 712 using the angular sensor of the carriage servomotor 712, and the rotation speed data 718 of the mandrel 704 obtained using the mandrel rotation speed sensor 719, in case of mandrel assisted mechanism is a servomotor 720 using the angular sensor of the mandrel servomotor 720. Each revolution of the mandrel 704 corresponds to one Displacement=WIRE STEP=Displacement carriage unit pitch. The mandrel rotation speed (RPM), “Z”, implies a carriage displacement speed=Z*PITCH/Minute”. The pitch control is determined by the carriage close loop assisted mechanism 712-719 and the mandrel assisted mechanism by the guidance of the two sets of coaxial guidance rollers 706A-D and wire guidance groove rollers 708A-B that deposit the wire 710 in the mandrel 704. The Displacement carriage unit control is performed to control the pitch by means of the carriage close loop assisted mechanism 712-719, the carriage position sensor 717, the carriage position signal, the control unit 716, a feedback signal 715 and the mandrel assisted mechanism. A close loop control software (e.g. PID, PLC) is executed to control the relation between displacements of the carriage unit 702 and mandrel 704 rotation speed. The pitch control is initialized by (i) setting and introduction of pitch through the touchscreen or keypad, (ii) determination of rotation speed (rpm) of the mandrel 704 and the positional signal of the carriage unit 702, (iii) In case, the control unit 716 is PLC type, the pitch is automatically selected by user selection of a composite hose reference in a human interface device.

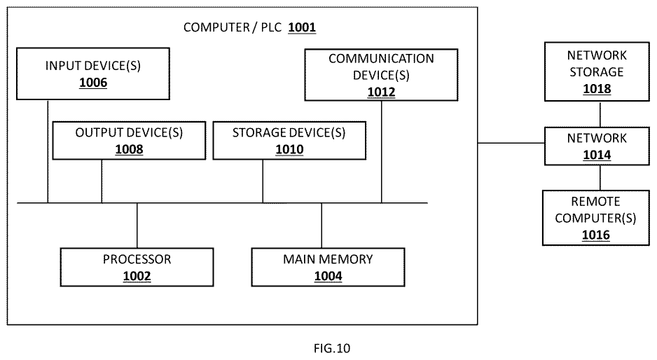

FIG. 10 illustrates a general computer or PLC architecture 1000 that can be appropriately configured to implement components disclosed in accordance with various embodiments. The general computing architecture 1000 can include various common computing elements, such as a computer 1001, a network 1014, and one or more remote computers 1016. The computer 1001 may be server, a desktop computer, a laptop computer, a tablet computer or a mobile computing device. The computer 1001 may include a processor 1002, a main memory 1004 and a system bus. The processor 1002 may include one or more processing units that can operate independently of each other. The main memory 1004 may include volatile devices, non-volatile devices, or other random-access memory devices. The computer 1001 may include secondary storage 1010 that may include one or more removable and/or non-removable storage units that stores an operating system to manages various applications on the computer 1001. The secondary storage 1010 may also be used to store software configured to implement the components of the embodiments disclosed herein and that may be executed as one or more applications under the operating system. The computer 1001 may also include communication device(s) 1012 through which the computer communicates with other devices, such as one or more remote computers 1016, over wired and/or wireless computer networks 1014. The communication device(s) 1012 may communicate over Wi-Fi, Bluetooth, and/or mobile telephone networks. The computer 1001 may also access network storage 1018 through the computer network 1014. The network storage 1018 may include a network attached storage device or a cloud-based storage. The operating system and/or software may alternatively be stored in the network storage 1018. The computer 1001 may have various input device(s) 1006 for example, keyboard, mouse, touchscreen, camera, microphone, or a sensor. Output device(s) 1008 for example, a display, speakers, printer. The storage devices 1010, communication device(s) 1012, input devices 1006 and output devices 1008 may be integrated within a computer system or may be connected through various input/output interface devices on the computer.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention.

1. A device for helical winding of a wire around a mandrel in the manufacture of composite hoses with a controlling means for pitch of the helical winded wire, as the wire is helical winded onto the mandrel or on the external layer of the composite hose, wherein the device comprises:
a carriage unit configured to move alongside the mandrel mounted on a longitudinal guide as the mandrel-rotates about its axis,
the carriage unit comprising two sets of coaxial guidance rollers that move laterally, and vertical in unison radially to the mandrel and swing coaxially in unison with the mandrel, and a first set of wire guidance groove rollers that guide and tension the wire,
wherein the carriage unit comprises, a means for controlling the pitch of the wire as the wire is helically winded onto the mandrel or on an external layer of the composite hose, wherein the means for controlling the pitch of the wire comprises a carriage closed loop assisted mechanism that control the displacement alongside the mandrel, the two sets of coaxial guidance rollers and the first set of wire guidance groove rollers, that move on a swing in unison and are pushed by a first pneumatic cylinder; and
a control unit configured to regulate the rotation of the carriage closed loop assisted mechanism to maintain the pitch of the helical wounded wire at a constant predetermined value, wherein the control unit regulates the rotation of the carriage closed loop assisted mechanism based on positional data of the carriage unit and rotation speed of the mandrel.

2. The device of claim 1, wherein the carriage closed loop assisted mechanism is configured to maintain a constant pitch, wherein the pitch is predetermined for each composite hose diameter and typology, and type of the wire material, diameter of the wire material.

3. The device of claim 1, wherein the two sets of coaxial rollers and the first set of wire guidance groove rollers keep the application point of the wire in a precise position relative to the mandrel following the displacements and bendings of the mandrel.

4. The device of claim 3, wherein the first set of wire guidance groove rollers are guided by a supporting unit guided by the two sets of coaxial rollers moving and swinging in unison and configured to move and swing synchronously with the displacements and bendings of the mandrel.

5. The device of claim 1, the positional data of the carriage unit is obtained using the displacement control of the carriage unit or angular control of the carriage closed loop assisted mechanism and the rotation speed of the mandrel is obtained using an angular control of the mandrel assisted mechanism.

6. The device of claim 1, wherein the carriage unit comprises, a means for controlling the tension of the wire as the wire is helical winded onto the mandrel or on the external layer of the composite hose, wherein the means for controlling the tension of the wire comprises a second set of wire guidance groove rollers arranged in zig-zag where the wire pass in between, one or more of them displaceable exert a force against the wire pushed by one or more second pneumatic cylinder simultaneously pushing the wire against the other fixed wire guidance groove rollers bending the wire in a predeterminate pull tension.

7. The device of claim 6, wherein the tension is predetermined for each composite hose diameter and typology, and type of the wire material and diameter of the wire material, wherein the one or more second pneumatic cylinder is configured to maintain constant wire tension.

8. The device of claim 6, wherein the second set of wire guidance groove rollers comprising a displaceable roller and fixed rollers.

9. The device of claim 8, wherein the tension is controlled by a pre-determined pressure that pushes the displaceable roller against the fixed rollers passing the wire between them and bending the wire as in a “chicane curve” by the one or more second pneumatic cylinder bending the wire in a predeterminate pull tension.

10. The device of claim 7, wherein the tension wire material is selected according to metal wire mainly Aluminum, Steel, Stainless Steel and covered by Plastic, mainly Polytetrafluoroethylene (PTFE), Polypropylene (PP), Polyethylene (PE), Polyamide (PA).

11. A device for winding a wire around a mandrel in the manufacture of composite hoses with a controlling means for tension of the winded wire, as the wire is helical winded onto the mandrel or on the external layer of the composite hose wherein the device comprising:
a carriage unit configured to move alongside the mandrel mounted on a longitudinal guide as the mandrel rotates about its axis,
the carriage unit comprising two sets of coaxial guidance rollers that move laterally, and vertical in unison radially to the mandrel and swing coaxially in unison with the mandrel, and a first set of wire guidance groove rollers that guide the wire, wherein the two sets of coaxial guidance rollers and the first set of wire guidance groove rollers are pushed by a first pneumatic cylinder;
wherein the carriage unit comprises, a means for controlling the tension of the wire as the wire is winded onto the mandrel or on the external layer of the composite hose, wherein the means for controlling the tension of the wire comprises a second set wire guidance groove rollers arranged in zig-zag where the wire pass in between, one or more of them displaceable exert a force against the wire pushed by one or more second pneumatic cylinder simultaneously pushing the wire against the other fixed wire guidance groove rollers bending the wire in a predetermined pull tension.

12. The device of claim 11, wherein the tension is predetermined for each composite hose diameter and typology, and type of the wire material and diameter of the wire material, wherein the one or more second pneumatic cylinder is configured to maintain constant wire tension.

13. The device of claim 11, wherein the second set wire guidance groove rollers comprising a displaceable roller and two fixed rollers.

14. The device of claim 13, wherein the tension is controlled by a pre-determined pressure that pushes the displaceable roller against the two fixed rollers passing the wire between them and bending the wire as in a “chicane curve” by the one or more second pneumatic cylinder, bending the wire in a predetermined pull tension.

15. The device of claim 12, wherein the tension wire material is selected according to metal wire mainly Aluminum, Steel, Stainless Steel and covered by Plastic, mainly Polytetrafluoroethylene (PTFE), Polypropylene (PP), Polyethylene (PE), Polyamide (PA).
